(19) United States
(12) Patent Application Publication
(10) Pub. No.: US 2023/0373289 A1
(43) Pub. Date: Nov. 23, 2023

(54) Modular System for an Energy Storage Device Floor Assembly for an Electrically Operatable Passenger Car, and Method for Producing Such an Energy Storage Device Floor Assembly

(71) Applicant: Bayerische Motoren Werke Aktiengesellschaft, Muenchen (DE)

(72) Inventors: Ronny GROSSE, Eichenau (DE); Benjamin KRAUS, Hallbergmoos (DE); Peter MONNERJAHN, Unterschleissheim (DE); Martin SCHUSTER, Muenchen (DE); Roland WANKA, Buch am Erlbach (DE)

(21) Appl. No.: 18/028,254

(22) PCT Filed: Nov. 9, 2021
(86) PCT No.: PCT/EP2021/081067

§ 371 Date: Mar. 24, 2023

(30) Foreign Application Priority Data
Nov. 11, 2020 (DE) 10 2020 129 667.3

(51) Int. Cl. B60K 6/28; B60L 50/60; B60K 15/063; B62D 25/20; B60K 1/04; B60K 13/04

(52) U.S. Cl. CPC B60K 6/28; B60L 50/66; B60K 15/063; B62D 25/2036; B60K 1/04; B60K 13/04; B60K 2015/0634; B60Y 2400/10; B60Y 2400/112; B60Y 2200/92; B60Y 2200/91; B60K 2001/0438

(57) ABSTRACT

A modular system is provided for an energy storage device floor assembly for an electrically operatable passenger car, including a cross-design variant floor assembly which has a main floor and a rear floor. In a first design variant for a passenger car with a solely electric drive, an energy storage device is provided which extends both below the main floor as well as the rear floor, and in a second design variant for a passenger car with a hybrid drive, an energy storage device, which extends solely below the main floor, and a fuel tank, which extends below the rear floor, are provided. A method is disclosed for producing such an energy storage device floor assembly.

### BACKGROUND AND SUMMARY

The invention relates to a modular system for an energy storage device floor assembly for an electrically operatable passenger car. Furthermore, the invention relates to a method for producing such an energy storage device floor assembly.

For many of the passenger cars offered in the future, it is planned to offer customers different drive concepts within a vehicle series. For example, in addition to vehicles with solely internal combustion engine drive (ICE), vehicles with electric drive (xEV) will also be offered. In the case of these vehicles with electric drive (xEV), a distinction is made, for example, between vehicles with solely electric drive (BEV) and vehicles with hybrid drive (PHEV), in which an internal combustion engine is also provided in addition to the electric drive. As is well known, these different drive concepts require a wide variety of installation spaces within the vehicle, in which the corresponding units, components or the like of the particular drive are arranged. This also causes considerable adaptations to the body-in-white or body structure of previous vehicles, which make the production or assembly of the different variants within a vehicle series considerably more difficult and, in particular, more expensive.

It is therefore the object of the present invention to create a modular system and a method of the type described at the outset, by means of which the manufacture and assembly of corresponding energy storage device floor assemblies for design variants of passenger cars, in particular of a vehicle series, can be considerably simplified and consequently realized in particular at lower cost.

This object is achieved according to the invention by a modular system and by a method for producing an energy storage device floor assembly having the features of the independent claims. Favorable developments are the subject of the dependent claims.

The modular system according to the invention comprises a cross-design variant floor assembly and has a main floor and a rear floor arranged behind it in the longitudinal direction of the vehicle, wherein, in a first design variant of the energy storage device floor assembly for a passenger car with an exclusively electric drive (BEV), an energy storage device is provided which extends below both the main floor and the rear floor, and wherein, in a second design variant of the energy storage device floor assembly for a passenger car with hybrid drive (PHEV), an energy storage device, which extends merely below the main floor, and a fuel tank, which extends below the rear floor, are provided.

According to the invention, a uniform cross-design variant floor assembly is therefore provided for all electrically operatable design variants (xEV)—for example within a vehicle series—and is diversified at least substantially only by a suitable arrangement of the particular components of the corresponding drive (BEV, PHEV). Accordingly, the particular energy storage device floor assembly for the corresponding associated design variant (BEV, PHEV) of the energy storage device floor assembly diversifies in particular by the design of a longer energy storage device (BEV) on the one hand and a shorter energy storage device (PHEV) or a fuel tank in the region of the rear floor (PHEV) on the other hand. Or, in other words: while in the case of the energy storage device floor assembly for vehicles with a solely electric drive (BEV) both the entire length below the main floor and the rear floor is available for the energy storage device, in the case of that design variant of the energy storage device floor assembly for a hybrid drive (PHEV), an energy storage device is used which extends only in the region of the main floor, wherein the corresponding fuel tank is provided behind it in the region of the rear floor.

In any case, the result is a modular system and a method for its production in which one and the same floor assembly can be used in a particularly favorable way on the body-in-white or on the vehicle body for different variants (BEV, PHEV) of the fully equipped energy storage device floor assembly. This has considerable advantages not only in terms of manufacturing technology but also in terms of assembly technology, as well as offering considerable cost-saving potential. For example, it is possible for one and the same fastening points to be provided on the body-in-white for components of the different design variants of the energy storage device floor assembly.

In a further embodiment of the invention, it has proven to be advantageous if the floor assembly, in the region of the main floor, has a tunnel in which an exhaust system extends at least over a length portion in the second design variant for the passenger car with hybrid drive (PHEV). This makes it particularly easy to install corresponding parts of the exhaust system, even in vehicles with hybrid drive (PHEV).

A further advantageous embodiment of the invention provides that the tunnel of the floor assembly in the first design variant for the passenger car with an exclusively electric drive (BEV) serves to accommodate an upper partial region of the energy storage device. In this way, optimum utilization of the installation space can also be achieved in a design variant with a solely electric drive (BEV).

It has also proven to be advantageous if in the second design variant for the passenger car with hybrid drive (PHEV), a tunnel is formed in the energy storage device. Advantageously, the exhaust system can run in this tunnel, at least in portions of its length, so that the exhaust system can be easily routed underneath the energy storage device floor assembly.

It is also advantageous if in the first design variant for the passenger car with an exclusively electric drive (BEV), the energy storage device is fixed in the rear region to the floor assembly by means of a transverse brace running in the transverse direction of the vehicle. In this way, the energy storage device, which in a solely electric design variant (BEV) extends further to the rear in the longitudinal direction of the vehicle, can also be optimally connected or fixed to the floor assembly, for example near the rear end of the respective side sills. Another particular advantage is that the energy storage device can be replaced separately from a rear subframe by means of the transverse brace, or that the extremely long energy storage device, which extends far to the rear in the longitudinal direction of the vehicle, can also be fixed particularly favorably at its rear end on the body-in-white side, especially in the case of a design variant with an exclusively electric drive (BEV) of the energy storage device floor assembly.

In a further embodiment of the invention, in the second design variant for the passenger car with hybrid drive (PHEV), various struts are provided which are connected, on the one hand, to corresponding side sills and to the energy storage device and, on the other hand, to a rear subframe. The struts thus provide a particularly favorable connection of the rear subframe to the respective side sills, which in particular forms corresponding nodes at each side sill for load paths in the event of an accident-related application of force.

A further advantageous embodiment of the invention provides that a design variant-specific shear panel is arranged at the front end of the energy storage device and is fastened to the floor assembly and the energy storage device. In the case in particular of the second design variant of the energy storage device floor assembly for the passenger car with hybrid drive (PHEV), a cutout for the exhaust system is preferably provided in the shear panel. It is particularly advantageous here that both the shear panel for the first and the second design variant have the same fastening points on the floor assembly.

The advantages explained above in conjunction with the modular system according to the invention apply in the same way to the method for producing an energy storage device floor assembly for an electrically operatable passenger car by means of a modular system according to claim 10.

Further features of the invention can be found in the claims, the figures and the figure description. The features and combinations of features mentioned above in the description, as well as the features and combinations of features mentioned below in the figure description and/or shown alone in the figures, can be used not only in the combination indicated in each case, but also in other combinations or in isolation.

The invention will now be explained in greater detail with reference to a preferred exemplary embodiment and with reference to the drawings.

### BRIEF DESCRIPTION OF THE DRAWINGS

FIGS. 1a,b show a top view and a bottom view, respectively, of a cross-design variant floor assembly for an electrically operatable passenger car, which in a first design variant of the energy storage device floor assembly is used for a vehicle exclusively with electric drive (BEV) and in a second design variant of the energy storage device floor assembly is used for a vehicle with hybrid drive (PHEV).

FIG. 2 shows a bottom view of the energy storage device floor assembly according to the first design variant for a passenger car with an exclusively electric drive system (BEV) and an energy storage device extending rearward to a transverse span both below a main floor and below a rear floor.

FIGS. 3a,b show respective bottom views of the energy storage device floor assembly according to the second design variant for a passenger car with hybrid drive (PHEV) with an energy storage device extending only below the main floor and with a fuel tank extending below the rear floor, wherein a fuel tank and an exhaust system can be seen in FIG. 3b in addition to the energy storage device.

FIGS. 4a,b show respective sectional views along a sectional plane running in the transverse direction of the vehicle or in the vertical direction of the vehicle in the region of the main floor, wherein FIG. 4a shows the first design variant of the energy storage device floor assembly exclusively for an electric drive (BEV) and FIG. 4b shows the second design variant for a hybrid drive (PHEV) of the passenger car in question.

FIGS. 5a,b show respective longitudinal sectional views of the energy storage device floor assembly along a sectional plane running in the longitudinal direction of the vehicle or in the vertical direction of the vehicle in the region of the longitudinal center plane, wherein FIG. 5a shows the first design variant of the energy storage device floor assembly for a solely electric drive (BEV) and FIG. 5b shows the second design variant for a hybrid drive (PHEV) of the passenger car in question,

FIG. 6 shows respective longitudinal sectional views through the corresponding floor assembly of various design variants of the vehicle series of the corresponding passenger cars, wherein a floor assembly for a drive designed solely with an internal combustion engine (ICE) is shown at the top, a floor assembly analogous to the second design variant of the energy storage device floor assembly for a hybrid drive system (PHEV) is shown in the middle representation, and a floor assembly analogous to the first design variant of an energy storage device floor assembly for a solely electric drive system (BEV) is shown at the very bottom.

FIG. 7 shows a sectional top view of the energy storage device floor assembly according to an embodiment of the invention.

FIGS. 8a,b show respective partial bottom views of the energy storage device floor assembly in accordance with the first and second design variants, wherein a shear panel specific to the design variant can be seen at the front end of the particular energy storage device.

FIG. 9 shows a partial perspective view in a rear region of the energy storage device for the first design variant of the energy storage device floor assembly for a solely electric drive (BEV) analogous to FIG. 2.

### DETAILED DESCRIPTION OF THE DRAWINGS

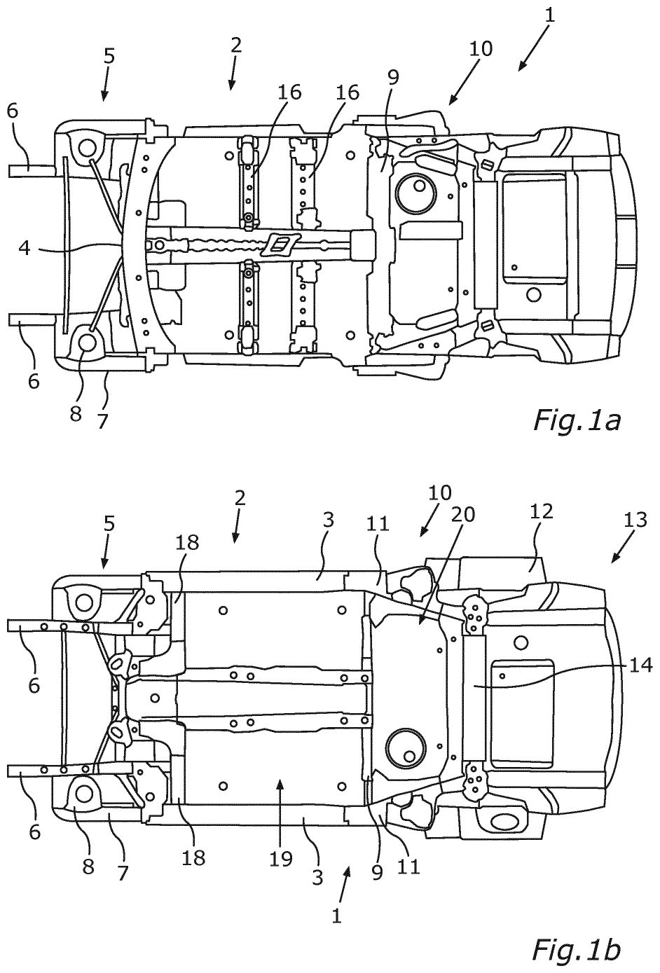

FIGS. 1a and 1b show a top view and a bottom view, respectively, of a cross-design variant floor assembly 1 for an electrically operatable passenger car. A main floor 2 can be seen here, which is bounded laterally by respective side sills 3 and extends forward to a front end wall 4. Towards the front, the main floor 2 is joined by a front-end structure 5 comprising respective engine longitudinal members or main longitudinal members 6. To the side of the engine longitudinal members 6 are respective wheel housing shells 7, which are provided at the top with respective spring strut domes 8.

Towards the rear, the main floor 2 extends to a heel wall 9, at which the main floor 2 merges into a rear floor 10. Viewed in the longitudinal direction of the vehicle, rear longitudinal members 11 adjoin the rear ends of the respective side sills 3 in the region of the heel wall 9 and extend on the inside of the respective wheel housing shells 12 in the region of a rear end 13 to the tail of the vehicle. At the level of the rear wheel housing shells 12, a crossmember 14 also extends in the transverse direction of the vehicle and connects the rear longitudinal members 11 to one another.

Also visible is a center tunnel 15, which extends starting from the heel plate 9 forward to the front end wall 4. The center tunnel 15 is also adjoined by respective seat crossmembers 16, which run outward in the transverse direction of the vehicle as far as the corresponding side sills 3.

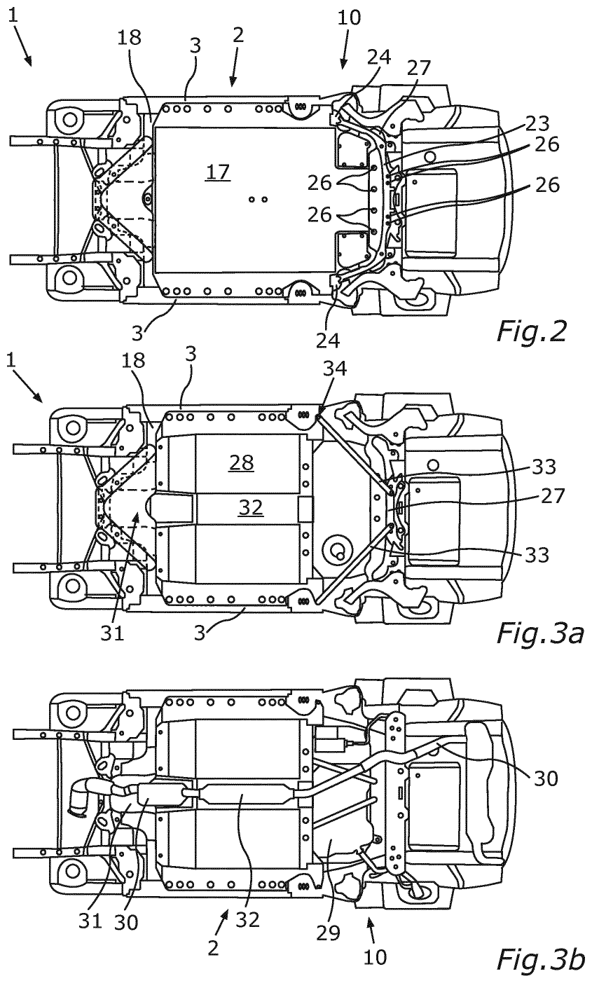

With reference to FIGS. 2 to 3b, it is now to be explained how the cross-design variant floor assembly 1 according to FIGS. 1a and 1b is equipped with different components in order to form either a first design variant of an energy storage device floor assembly for a passenger car with an exclusively electric drive (BEV), as shown in FIG. 2, or a second design variant of the energy storage device floor assembly for a passenger car with a hybrid drive (PHEV), as shown in FIGS. 3a and 3b. In other words, one and the same floor assembly 1 according to FIGS. 1a and 1b is used for both design variants (BEV, PHEV) of the energy storage device floor assembly for the body-in-white or for the vehicle body, and is diversified by assembling different components with regard to the two different design variants of the energy storage device floor assembly.

Thus, in accordance with the method according to the invention, the first design variant of the energy storage device floor assembly for a passenger car with an exclusively electric drive (BEV) is achieved in that a continuous energy storage device 17 is inserted on the underside of both the main floor 2 and the rear floor 10 and extends outward in the transverse direction of the vehicle as far as the respective side sills 3. Towards the front, the energy storage device 17 extends up to a front crossmember 18, which can be seen in FIG. 1b and towards the front delimits a receiving recess 19 of the main floor 2 for the energy storage device 17. On the outside, the receiving recess 19 is bounded by the side sills 3 and, towards the rear, by the heel plate 9. Towards the rear, the energy storage device 17 extends beyond the heel plate 9 into the region of a receiving recess 20 below the rear floor 10, wherein the receiving recess 20 is bounded at the front and rear by the heel plate 9 and the crossmember 14 respectively and at the outside by the longitudinal members 11.

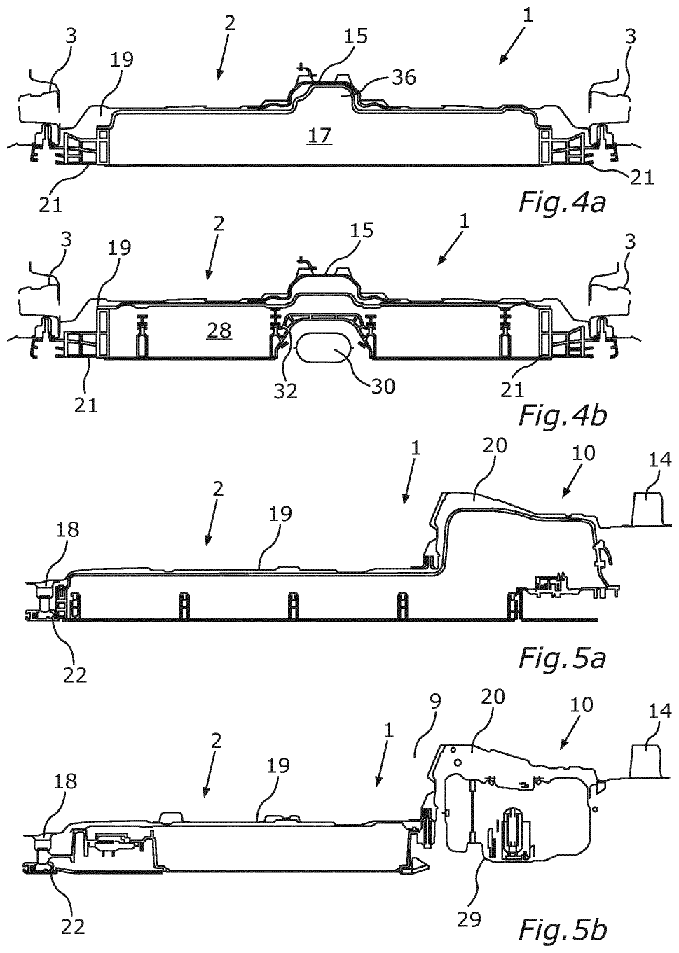

On the basis of FIGS. 4a and 5a, which show, respectively, the first design variant of the energy storage device floor assembly according to FIG. 2 in a cross-sectional view along a sectional plane running in the transverse direction of the vehicle and in the vertical direction of the vehicle in the region of the main floor 2 and a longitudinal sectional view along a sectional plane running in the vertical direction of the vehicle and in the longitudinal direction of the vehicle in the region of the longitudinal centerline of the vehicle, the specific arrangement of the energy storage device 17 within the receiving recesses 19 and 20 below the main floor 2 and the rear floor 10 can be seen. In particular, it can be seen from FIGS. 2, 4a and 5a that the energy storage device 17 is bolted to the side sills 3 on the outside by means of respective profiles 21. A front-side fastening of the energy storage device 17 by means of a profile 22 to the crossmembers 18 by way of various screw elements can also be seen in FIG. 5a.

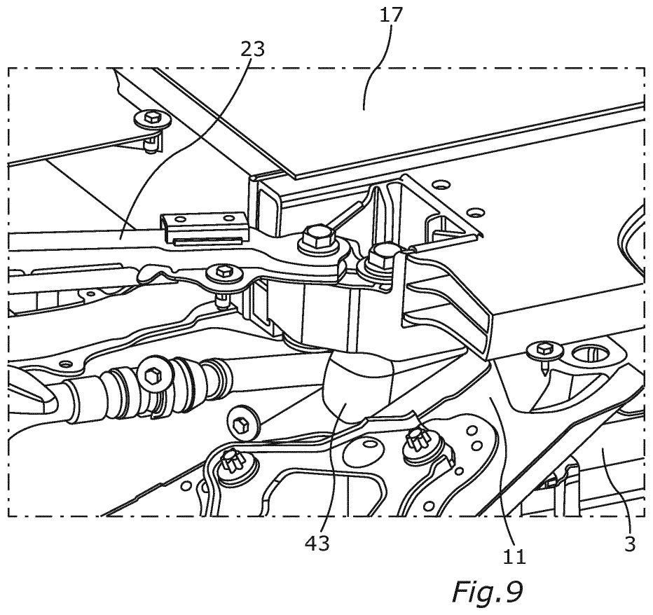

The rear attachment of the energy storage device 17 of the first design variant according to FIG. 2 is achieved by means of a transverse brace 23, which is attached with its respective front outer ends 24 in the transition region between the rear ends of the side sills 3 and the respective associated longitudinal members 11 (see FIG. 9). In addition, the transverse brace 23 is connected, on the one hand, by means of respective screw connections 25 to the rear end of the energy storage device 17 and, on the other hand, by means of respective screw connections 26 to a rear subframe 27. The transverse brace 23 can thus be used to dismantle the energy storage device or the rear subframe 27, which is separate from the high-voltage storage device 17, or vice versa. In addition, by means of the transverse brace 23, it is achieved that the energy storage device 17 also does not sag downward in its rear region, for example, which is connected to the floor assembly 1. In addition, the transverse brace 23 serves to protect the energy storage device, for example when approaching a curb, when approaching a bollard, or when driving over a bollard.

FIGS. 3a and 3b show the second design variant of the energy storage device floor assembly for a hybrid drive (PHEV) of the passenger car. In contrast to the first design variant according to FIG. 2, an energy storage device 28 is provided, which extends to the front or to the sides analogously to the energy storage device 17 according to the first design variant. Towards the rear, the energy storage device 28—as can also be seen in particular from FIG. 5b—ends at least substantially at the heel wall 9 in the longitudinal direction of the vehicle. In contrast to the first design variant, the energy storage device 28 is therefore not provided in the region of the rear floor 10.

Rather—as can be seen from FIGS. 3b and 5b—a fuel tank 29 for an internal combustion engine of the hybrid drive (PHEV) of the passenger car is arranged there. In addition, it can be seen from FIG. 3b that an exhaust system 30 runs from the front end 5 to the rear end 13 underneath the energy storage device floor assembly.

From the front, the exhaust system 30 runs lengthwise here—namely over a length portion 31—within the center tunnel 15 of the floor assembly 1. In addition, a tunnel 32 is recessed within the energy storage device 28 and as an extension of the length portion 31 of the center tunnel 15. This can also be seen in particular from FIG. 4b in the cross-sectional view of the energy storage device floor assembly according to the second design variant in the region of the main floor 2.

Lastly, FIG. 3a shows two struts 33, which are fastened on the one hand with respective front ends to the associated side sill 3 and with respective rear ends to the rear subframe 27. Thus, the rear subframe 27 is connected to the respective side sills 3 via the corresponding struts 33. In the region of respective node points 34, the respective struts 33 are also connected to the energy storage device 28. In the second design variant of the energy storage device floor assembly for a hybrid drive (PHEV) of the passenger car explained here, the energy storage device 28 is attached by its rear end to the heel plate 9 between the main floor 2 and the rear floor 10. This can also be seen, for example, from FIG. 5b.

As can further be seen from FIG. 4a, the energy storage device 17 of the first design variant (BEV) additionally comprises a partial region 36 which protrudes into the center tunnel 15 of the floor assembly 1.

Overall, it can therefore be seen that a modular system and a method for producing a corresponding energy storage device floor assembly have been created in which one and the same floor assembly 1 is used for both of the design variants described (BEV, PHEV), but which is equipped with different components of the respective drives (BEV, PHEV).

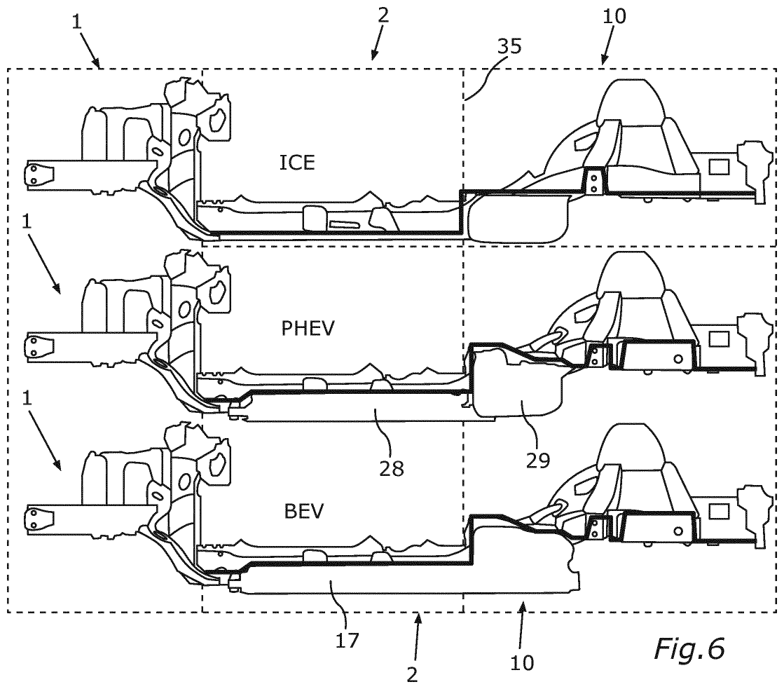

FIG. 6 again shows the floor assembly 1 in respective longitudinal sectional views analogous to FIGS. 5a and 5b or the second and first design variants (PHEV, BEV) of the present energy storage device floor assembly in the lower two illustrations. In addition, the upper illustration shows the floor assembly in its design for a drive solely with an internal combustion engine (ICE). The course of the main floor 2, the heel plate 9 and the rear floor 10 are indicated here with a bold line for clarity in all variants.

In particular, it can be seen here that at the level of a separation point 35 (between the main floor 2 and the rear floor 10), which corresponds to the heel plate 9, the respective floor assemblies 1 for the variant for ICE and for the variants for PHEV and BEV are designed differently towards the rear. In addition, it can be seen that the heel plate 9 is designed to be shorter in the variant for ICE than in the variants for PHEV and BEV, and that in the latter the rear floor 10 slopes somewhat downward toward the rear starting from the heel plate 9. In the variants for PHEV and BEV, a recess formed at the top is also provided behind the crossmember 14, for example to accommodate electronic components or drive components of the rear axle.

It can also be seen from FIG. 6 that the variants for PHEV and BEV, unlike the variant for ICE, have an upwardly formed recess in the region of the main floor 2 to accommodate the energy storage device 17 or 28, respectively.

A comparison of the variants for PHEV and BEV also shows that the floor assembly 1 is identical. This allows further synergy effects and allows an additional cost saving.

A further comparison of the variants for ICE, PHEV and BEV also shows that the front body or front end structure is the same. This allows further synergy effects and an additional cost saving.

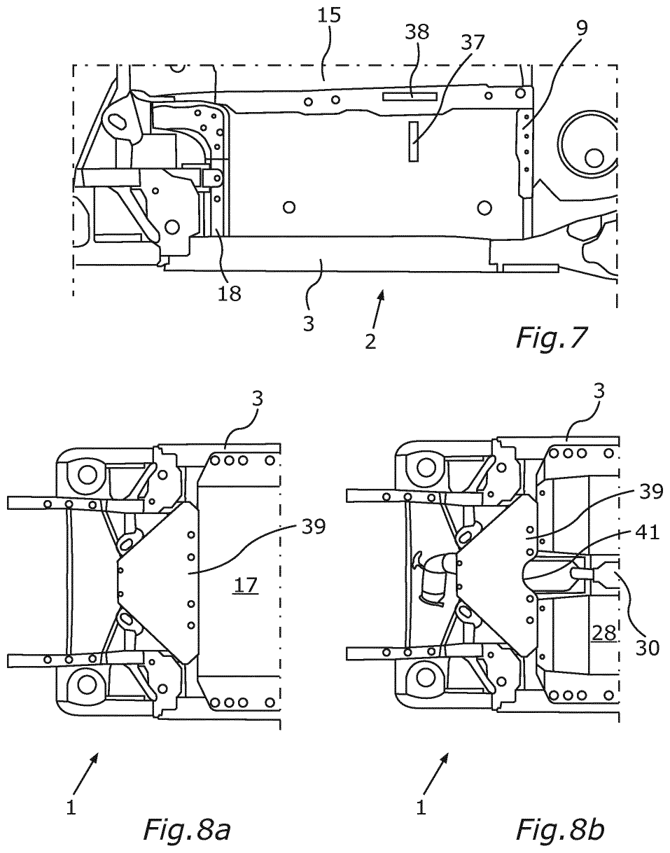

The position of the respective acoustic pads 37 for the first design variant (BEV) of the energy storage device floor assembly and for the second design variant (PHEV) can be seen from the partial bottom view shown in FIG. 7. By suitable arrangement of these acoustic pads 37, 38, the NVH properties of the vehicle, i.e. the properties with regard to noise, vibrations and harshness, can thus be improved, for example.

FIGS. 8a and 8b show in a respective sectional bottom view, different embodiments of respective shear panels 39, 40, which are arranged on the underside of the respective energy storage device floor assembly. FIG. 8a shows the shear panel 39 for the first design variant of the energy storage device floor assembly for a solely electric drive (BEV), while FIG. 8b shows the second design variant for a hybrid drive (PHEV). Subsequently, it can be seen from FIG. 8b that the shear panel 40 has cutouts 41 for the exhaust system 30.

FIG. 9 shows a partial perspective view of the rear region of the energy storage device 17 for the first design variant of the energy storage device floor assembly for a solely electric drive (BEV) analogous to FIG. 2. In particular, it can be seen here that the transverse brace 23 running in the transverse direction of the vehicle is fixed in the rear region of the energy storage device 17, and that the energy storage device 17 is connected in the connection region of the transverse brace 23 to a mount 43 fixed to the vehicle body. The mount 43 fixed to the vehicle body is attached here to the body on the underside of the rear longitudinal member 11.

### LIST OF REFERENCE SIGNS

1 floor assembly
2 main floor
3 side sill
4 end wall
5 front-end structure
6 main longitudinal member
7 wheel housing shell
8 spring strut dome
9 heel plate
10 rear floor
11 longitudinal member
12 wheel housing shell
13 rear end
14 crossmember
15 center tunnel
16 seat crossmember
17 energy storage device
18 crossmember
19 receiving recess
20 receiving recess
21 profile
22 profile
23 transverse brace
24 end
25 screw connection
26 screw connection
27 rear subframe
28 energy storage device
29 fuel tank
30 exhaust system
31 length portion
32 tunnel
33 strut
34 node point
35 separation point
36 partial region
37 acoustic pad
38 acoustic pad
39 shear panel
40 shear panel
41 cutout
43 mount

1.-10. (canceled)

11. A modular system for an energy storage device floor assembly for an electrically operatable passenger car, comprising:
a cross-design floor assembly comprising a main floor and a rear floor, wherein:
in a first design variant for a passenger car with an exclusively electric drive, an energy storage device extends below both the main floor and the rear floor, and
in a second design variant for a passenger car with a hybrid drive, an energy storage device extends only below the main floor, and a fuel tank extends below the rear floor.

12. The modular system according to claim 11, wherein
the floor assembly, in the region of the main floor, has a tunnel, and
an exhaust system extends at least over a length portion in the second design variant for the passenger car with the hybrid drive.

13. The modular system according to claim 12, wherein
the tunnel of the floor assembly in the first design variant for the passenger car with the exclusively electric drive serves to accommodate an upper partial region of the energy storage device.

14. The modular system according to claim 11, wherein
in the second design variant for the passenger car with the hybrid drive, a tunnel is formed in the energy storage device.

15. The modular system according to claim 11, wherein
in the first design variant for the passenger car with the exclusively electric drive, a transverse brace running in a transverse direction of the vehicle is fixed in a rear region of the energy storage device, and
the energy storage device is connected in a connection region of the transverse brace to a mount fixed to a vehicle body.

16. The modular system according to claim 15, wherein
the transverse brace is connected to a rear subframe.

17. The modular system according to claim 11, wherein
in the second design variant for the passenger car with the hybrid drive, struts are provided which are connected, on the one hand, to corresponding side sills and to the energy storage device and, on the other hand, to a rear subframe.

18. The modular system according to claim 11, further comprising:
a design variant-specific shear panel arranged at a front end of a respective energy storage device, the design variant-specific shear panel being fastened to the floor assembly and the respective energy storage device and to a front subframe.

19. The modular system according to claim 18, wherein
the shear panel in the second design variant for the passenger car with the hybrid drive has a cutout for an exhaust system.

20. A method for producing an energy storage device floor assembly for an electrically operatable passenger car via a modular system, the method comprising:
equipping in a cross-design variant floor assembly having a main floor and a rear floor:
(i) either in a first design variant for a passenger car with an exclusively electric drive, an energy storage device which extends below both the main floor and the rear floor, or
(ii) in a second design variant for a passenger car with a hybrid drive, an energy storage device which extends only below the main floor, and with a fuel tank which extends below the rear floor.
